(19) United States
(12) Patent Application Publication
(10) Pub. No.: US 2009/0308186 A1
(43) Pub. Date: Dec. 17, 2009

(54) Secure Method for Collecting and Analyzing Samples

(76) Inventors: Nicolas Bara, La Villetertre (FR); Benoit Schoeffler, Royat (FR)

Correspondence Address: HARNESS, DICKEY & PIERCE, P.L.C., P.O. BOX 828, BLOOMFIELD HILLS, MI, 48303, US

(21) Appl. No.: 12/085,485

(22) PCT Filed: Nov. 24, 2006
(86) PCT No.: PCT/FR2006/002584

§ 371 Date: Sep. 3, 2009

(30) Foreign Application Priority Data
Nov. 25, 2005 (FR) 05/11962

(51) Int. Cl. G01N 37/00; G06F 17/00; G01N 1/00

(52) U.S. Cl. 73/864.91; 235/375

(57) ABSTRACT

The invention concerns a secure method for collecting and analyzing samples using a device for storing samples comprising data storage means and at least one sampling receptacle capable of being associated therewith, the device being provided with means for verifying and ensuring the integrity of the receptacle before and after its use when said receptacle is associated with the device, the receptacle including data storage means already including data for identifying said receptacle, the method providing for recording of all data concerning sampling and analysis in the storage means.

### CROSS-REFERENCE TO RELATED APPLICATIONS

This application is a National Phase Entry of International Application No. PCT/FR2006/002584, filed Nov. 24, 2006, claiming priority to French Patent Application No. 05/11962, filed Nov. 25, 2005, both of which are incorporated herein by reference.

### BACKGROUND AND SUMMARY

The invention relates to a secure method for collecting and analysing samples.

In many fields, and particularly in the legal field, it is necessary to be able to guarantee the origin of a sample, such as a clue taken from the scene of a crime, the conditions under which it was collected and its integrity during subsequent handling of this sample. This is because, in the legal field, a sample collected at the scene of a crime may serve as evidence, possibly leading to the conviction or acquittal of a person on trial. It is therefore of the utmost importance to be able to certify with certainty the collection conditions and the integrity of the sample used as evidence in order to avoid any judicial error. In other words, it is necessary to be able to certify with certainty that the sample that underwent analysis was indeed present at the scene of the crime and that it has not been modified, swapped or degraded during handling. At present, the guarantee concerning the collection conditions and the origin of the samples and also the conditions under which it was analysed rests on the word of the police and the scientists in charge of the analysis.

In other fields, particularly the medical field, the guarantee of the collection conditions and origin of the samples analysed may prove to be of the utmost importance. This is because, for reasons of viability of the sample and of relevance of the analysis, it is important to know the time that has elapsed between the collection and the actual analysis of the sample. This time must be as short as possible and must not exceed the period of viability of the sample. At present, this guarantee rests on the human word and on the indications given by the person in charge of collection. The date of collection may therefore be questioned. The human word can always be questioned regardless of whether the persons giving their word do so in good faith or not. During a trial, the guarantee concerning the collection and analysis conditions of a sample may be the subject of debates and questions which may lead to the conviction or acquittal of a person on trial without there being any certainty that justice has indeed been done in the case. It will therefore be understood that it is necessary to provide this guarantee in a certain and reliable manner and not simply via the human word.

The invention aims to provide a solution to this problem by proposing a secure method for collecting and analysing samples, in which all the information relating to the collection and analysis are recorded on a tamper-proof support in which the sample is collected.

### DETAILED DESCRIPTION

The invention relates to a secure method for collecting and analysing samples using a device for storing the samples which comprises an information storage means and at least one collection receptacle which can be associated therewith, the device being equipped with means for verifying and guaranteeing the integrity of the receptacle before and after use thereof when said receptacle is associated with the device, the receptacle comprising information storage means which previously comprise identification information relating to said receptacle, said method being characterised in that it comprises the following steps:
a. identifying at least one person charged with the collection, and storing this identification in the information storage means of the device and in the storage means of the receptacle;
b. writing the place, date and time of collection to the storage means of the device and to the storage means of the receptacle;
c. identifying the collection receptacle and storing this identification in the storage means of the device;
d. verifying the integrity of the collection receptacle before use thereof;
e. opening the receptacle, if the verification indicates that the receptacle has not previously been used, and collecting the sample;
f. closing the receptacle and applying means for guaranteeing the integrity of the receptacle after use thereof;
g. transmitting the data stored in the storage means to remote storage means;
h. subsequently analysing the sample.
   Thus, the information relating to the collection conditions and to the preservation of the sample are written on a support which is irreversibly linked to the sample. In this way, a novel guarantee is provided concerning the origin and authenticity of the sample.

Furthermore, according to one embodiment, the step of identifying at least one person in charge of the collection and/or analysis is supplemented by an identification of at least one witness and by the storage of this identification in the storage means of the device and in the storage means of the receptacle. Thus, the steps necessarily carried out by physical persons take place under the surveillance of at least one clearly identified witness, which reduces the possibilities for fraudulent manipulation of the samples. In order to guarantee that the place, date and time of collection are exact, the information relating to the place of collection is supplied to the storage means by a positioning device, such as a GPS, the data of which cannot be falsified, and the information relating to the date and time of collection is supplied to the storage means by a clock, of the atomic clock type which also cannot be falsified. The device for storing the samples and the collection receptacle which can be associated therewith conform for example to the biological analysis system described in the document FR-2 787 042 and in the document FR-2 865 190 filed in the name of the applicant.

Such an analysis system makes it possible to avoid any sample identification error and to obtain an automatic traceability of the samples. Furthermore, the receptacle makes it possible to see whether or not integrity has been conferred thereon. In such a system, the information storage means of the receptacle are formed by an electronic label, the content of which can be read remotely. Furthermore, it is provided that the storage device is equipped with means for verifying and guaranteeing the integrity of the receptacle before and after use thereof when said receptacle is associated with the device. In order to obtain information about the integrity of the receptacle, the latter may conform to the tube described in the document FR-2 865 190 as indicated above.

According to one embodiment and in order to guarantee and certify the analysis conditions of the samples, the analysis step h. may comprise the following steps:
i. identifying at least one person charged with the analysis, and storing this identification in the storage means;
j. verifying the conformity of the identity of the receptacle to be analysed based on information contained in the remote storage means with the identity of the receptacle handled by the person charged with the analysis based on information contained in the storage means of said receptacle;
k. verifying the integrity of the collection receptacle after it has been closed during the collection process;
l. actually analysing the sample.
   Thus, the same guarantees are provided during the analysis as during the collection.

In order to preserve all the information in the storage means of the device and in the storage means of the receptacle, it is possible to furthermore provide one or more steps of recording comments relating to the collection in the storage means of the device and in the storage means of the receptacle during the collection and/or analysis of the sample. Thus, it is also possible to certify the location and the time at which the comments relating to the sample were made. In order to facilitate visual identification of the sample and thus to avoid electronic reading of the receptacle when it is desired to identify it, the method may furthermore comprise a step of printing a visual identification means which is associated with the receptacle after identification of the latter by the collection device.

In the case where the analysis is not carried out directly after collection, the method comprises a storage step between the collection steps and the analysis steps. A writing of storage data to the storage means of the device and to the storage means of the receptacle, such as the storage date, the storage location and the sample removal date, is carried out during the storage step. It is possible to provide steps of encrypting the information recorded in the storage means of the device and in the storage means of the receptacle in order to ensure that the recorded information can be read only by persons having sufficient authority to do so. The device is able to receive a plurality of collection receptacles, the identification steps being repeated for each receptacle. Thus, all the clues collected at the scene of a crime can be associated with the same device.

The use of the device and of the receptacle associated therewith takes place as follows: the collection receptacle is associated with the device before step a. then is removed from the device during step e. then is reassociated with the device during step f., the means for guaranteeing the integrity of the receptacle after use thereof being applied by the device. A data input and reading element for writing and reading the information on the storage means of the device and on the storage means of the receptacle, said element being handled by the person identified in said storage means. Such an element is for example a portable computer or a pocket electronic assistant, such as a PDA organiser (palm digital assistant), making it possible to input information and to transmit this information. Such input and reading elements are commercially available. The positioning device and the clock may be integrated in the input and reading element.

The certain identification of the user of such an input and reading element may be carried out by means of a biometric identification system. The user is then identified for example by means of his digital fingerprint. Such an identification system is also available commercially and can easily be associated with the input and reading element. The storage means of the device and of the receptacle may also store photographs, for example of the scene of the crime. It is then possible to use a digital apparatus which sends the photos taken to these storage means.

The method according to the invention therefore makes it possible to combine all the information relating to a collection of samples in a storage means which is irreversibly linked to the support containing these samples, which provides a guarantee concerning the authenticity of this information. Such a method can be used in all fields in which the verification of the authenticity of the conditions under which samples are collected, stored and analysed may prove to be of the utmost importance.

1. A secure method for collecting and analysing samples using a device for storing the samples which comprises an information storage and at least one collection receptacle which can be associated therewith, the device verifying and guaranteeing the integrity of the receptacle before and after use thereof when said receptacle is associated with the device, the receptacle comprising an information storage which previously comprise identification information relating to said receptacle, said method comprising:
a. identifying at least one person charged with the collection, and storing this identification in the information storage of the device and in the storage of the receptacle;
b. writing the place, date and time of collection to the storage of the device and to the storage of the receptacle;
c. identifying the collection receptacle and storing this identification in the storage of the device;
d. verifying the integrity of the collection receptacle before use thereof;
e. opening the receptacle, if the verification indicates that the receptacle has not previously been used, and collecting the sample;
f. closing the receptacle and guaranteeing the integrity of the receptacle after use thereof;
g. transmitting the data stored in the storage to a remote storage; and
h. subsequently analysing the sample.

2. The secure method according to claim 1, wherein the analysis step comprises the following steps:
i. identifying at least one person charged with the analysis, and storing this identification in the storage;
j. verifying the conformity of the identity of the receptacle to be analysed based on information contained in the remote storage with the identity of the receptacle handled by the person charged with the analysis based on information contained in the storage of said receptacle;
k. verifying the integrity of the collection receptacle after it has been closed during the collection process; and
l. actually analysing the sample.

3. The secure method according to claim 1, wherein the information relating to the place of collection is supplied to the storage by a positioning device.

4. The secure method according to claim 1, wherein the information relating to the date and time of collection is supplied to the storage by a clock.

5. The secure method according to claim 1, wherein the information storage of the receptacle is formed by an electronic label, the content of which can be read remotely.

6. The secure method according to claim 1, wherein the step of identifying at least one person in charge of the collection and/or analysis is supplemented by an identification of at least one witness and by the storage of this identification in the storage of the device and in the storage of the receptacle.

7. The secure method according to claim 1, further comprising recording comments relating to the collection in the storage of the device and in the storage of the receptacle during the collection and/or analysis of the sample.

8. The secure method according to claim 1, further comprising printing a visual identification which is associated with the receptacle after identification of the latter by the collection device.

9. The secure method according to claim 1, further comprising a storage step between the collection steps and the analysis steps, the writing of storage data to the storage of the device and to the storage of the receptacle being carried out during the storage step.

10. The secure method according to claim 1, further comprising encrypting the information recorded in the storage of the device and in the storage of the receptacle.

11. The secure method according to claim 1, wherein the device is able to receive a plurality of collection receptacles, the identification steps being repeated for each receptacle.

12. The secure method according to claim 1, wherein the collection receptacle is associated with the device before step a. then is removed from the device during step e. then is reassociated with the device during step f., and the for guaranteeing the integrity of the receptacle after use thereof being applied by the device.

13. The secure method according to claim 1, further comprising using a data input and reading element to write and read the information on the storage of the device and on the storage of the receptacle, said element being handled by the person identified in said storage.
